(19) United States
(12) Patent Application Publication
(10) Pub. No.: US 2009/0085654 A1
(43) Pub. Date: Apr. 2, 2009

(54) Biasing Circuit with Fast Response

(76) Inventor: Yung-Cheng Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/025,674

(22) Filed: Feb. 4, 2008

(30) Foreign Application Priority Data
Sep. 29, 2007 (TW) 096136536

(51) Int. Cl. G05F 1/10

(52) U.S. Cl. 327/543; 327/538

(57) ABSTRACT

A biasing circuit includes a reference current source, a first transistor, a second transistor, and a voltage buffer. The first transistor includes a first connection end coupled to the reference current source, a control end, and a second connection end coupled to a system grounding end. The second transistor includes a control end coupled to the control end of the first transistor, a first connection end coupled to a system power supply end, and a second connection end coupled to the system grounding end. The voltage buffer includes an input end coupled to an output end of the reference current source and the first connection end of the first transistor, and an output end coupled to the control ends of the first transistor and the second transistor. The first transistor and the second transistor constitute a current mirror.

### BACKGROUND OF THE INVENTION

1. Field of the Invention

The present invention relates to a biasing circuit with fast response, and more particularly, to a biasing circuit by adding an output buffer to speed up response.

2. Description of the Prior Art

Differential amplifiers are one of the common elements used in circuit design. In a differential amplifier circuit, a current source with high output impedance must be coupled to the emitter of the differential amplifier to increase the common-mode rejection ratio (CMRR) of the differential amplifier circuit and reduce noise effect. Therefore, in the prior art, a circuit is used for providing infinite impedance ideally (i.e., an ideal current source). Such a circuit possesses a reflection function just like a mirror, which is called current mirror. The current mirror usually includes an input end and an output end, wherein the input end is used for receiving a current value of a reference current source and the output end is used for generating a corresponding current having a current value determined according to designed values of the reference current source and the current mirror. Because the current mirror can provide a relatively accurate and stable current value, it is widely used in circuit designs.

Please refer to FIG. 1. FIG. 1 is a diagram of a biasing circuit 10 with a regulated capacitor according to the prior art. The biasing circuit 10 includes a first transistor M₁₁, a second transistor M₂₂, and a regulated capacitor Cb. The first transistor M₁₁ has a control end 102, a first end 104, and a second end 106, wherein the control end 102 of the first transistor M₁₁ is coupled to a control end 202 of the second transistor M₂₂, the first end 104 is coupled to a current source (not shown in FIG. 1) for receiving an input current Iin, and the second end 106 is coupled to a system grounding end. The second transistor M₂₂ has a control end 202, a first end 204, and a second end 206, wherein the control end 202 of the second transistor M₂₂ is coupled to the control end 102 of the first transistor M₁₁, the first end 204 is coupled to a system power supply end, and the second end 206 is coupled to the system grounding end. The first transistor M₁₁ and the second transistor M₂₂ constitute a current mirror, thus the second transistor M₂₂ provides a corresponding output current lout flowing into the second transistor M₂₂ according to the input current Iin. The regulated capacitor Cb is coupled to control end 102 of the first transistor M₁₁ and the control end 202 of the second transistor M₂₂ for suppressing noise. Nevertheless, the regulated capacitor Cb restricts application performance of some circuits.

Please refer to FIG. 2. FIG. 2 is a diagram of a biasing circuit 20 capable of increasing slew rate according to the prior art. The biasing circuit 20 is similar to the biasing circuit 10 in FIG. 1, which adds a reference current source 22, an adjustment current source 24, a first switch SW11, and an output buffer 26 to reach a goal of increasing slew rate. The reference current source 22 is coupled to a power supply end VDD for providing a reference current I_{REF1}. The adjustment current source 24 is coupled to the reference current source 22 in parallel for providing an adjustment current I_{ADD1}. The first switch SW11 is coupled between the adjustment current source 24 and the first end 104 of the first transistor M₁₁. The first switch SW11 has a control end for receiving a clock signal CLK₁ and is controlled to be turned on/turned off according to the clock signal CLK₁. The first end 104 of the first transistor M₁₁ is coupled to the reference current source 22 and the first switch SW11. When the first switch SW11 is turned on, the reference current I_{REF1} and the adjustment current I_{ADD1} are received by the first end 104 of the first transistor M₁₁. When the switch SW11 is turned off, only the reference current I_{REF1} is received by the first end 104 of the first transistor M₁₁. Please note that, in the descriptions of the present invention, turning on the switch means that short circuit when the switch is conducted, and turning off the switch means that open circuit when the switch is disconnected. The first end 204 of the second transistor M₂₂ is coupled to the output buffer 26. The first transistor M₁₁ and the second transistor M₂₂ constitute a current mirror. That is, the current generated by the second transistor M₂₂ corresponds to the current of the first transistor M₁₁. Furthermore, there are many kinds of combinations of connections between the first switch SW11 and the current mirror, and this embodiment is presented merely for describing the features of the present invention, which should not be limitations of the scope of the present invention. If the first switch SW11 is turned on, the current flowing through the first transistor M₁₁ is increased from I_{REF1} to (I_{REF1}+I_{ADD1}). Thus the current flowing through the second transistor M₂₂ also becomes larger, which can increase the slew rate of the output buffer 26. The first switch SW11 is controlled by the clock signal CLK₁. That is, the time for increasing the slew rate is determined by the clock signal CLK₁, which can reach the goal of saving power and speeding up simultaneously. The regulated capacitor Cb is coupled to the control end 102 of the first transistor M₁₁ and the control end 202 of the second transistor M₂₂ for suppressing noise. However, the efficiency for increasing the slew rate of the biasing circuit 20 is critically restricted.

Please refer to FIG. 3 and FIG. 2. FIG. 3 is a diagram of waveforms of the clock signal CLK₁ and a voltage Vy of a node Y shown in FIG. 2. When the clock signal CLK₁ is transformed from low level to high level, the first switch SW11 is turned on at this time. Theoretically, the loading on the node Y can be omitted, and thus the transient current flowing through the first transistor M₁₁ is increased from I_{REF1} to (I_{REF1}+I_{ADD1}) and the voltage Vy of the node Y should be immediately changed to a desired voltage corresponding to such current. In fact, however, the loading on the node Y is increased due to the regulated capacitor Cb, which means the adjustment current I_{ADD1} must first charge the loading of the node Y. The loading not only restricts the rising speed of the node Y, but also restricts the current mapped to the second transistor M₂₂. Similarly, when the clock signal CLK₁ is transformed from high level to low level, the voltage Vy of the node Y should return to the desired voltage corresponding to the reference current I_{REF1}. Therefore, the first transistor M₁₁ needs to provide extra current to discharge the loading of the node Y.

In applications of conventional current mirrors, the regulated capacitor Cb is added to the current mirrors to suppress noise. But the regulated capacitor Cb restricts application performance of some circuits. As shown in FIG. 2 and FIG. 3, the loading of the node Y is increased by the regulated capacitor Cb, which makes the voltage Vy of the node Y need to first charge or discharge the regulated capacitor Cb when transforming. As a result, the efficiency for increasing the slew rate of the biasing circuit 20 is critically restricted, which causes the current mirror to be unable to mirror the input current to the output current immediately and wastes extra power consumption.

### SUMMARY OF THE INVENTION

The present invention discloses a biasing circuit with fast response. The biasing circuit includes a reference current source, a first transistor, a second transistor, and a voltage buffer. The reference current source has an output end for providing a reference current. The first transistor has a control end, a first connection end, and a second connection end, wherein the first connection end is coupled to the output end of the reference current source and the second connection end is coupled to a system grounding end. The second transistor has a control end, a first connection end, and a second connection end, wherein the control end is coupled to the control end of the first transistor, the first connection end is coupled to a system power supply end, and the second connection end is coupled to the system grounding end. The voltage buffer has an input end coupled to the output end of the reference current source and the first connection end of the first transistor, and an output end coupled to the control end of the first transistor and the control end of the second transistor. The first transistor and the second transistor constitute a current mirror. The voltage buffer is a source follower, an emitter follower, or an operational amplifier (op amp) with direct feedback. The biasing circuit is applied to a cascode circuit. The biasing circuit further includes at least a third transistor, wherein a control end of the third transistor coupled to the control end of the first transistor and the control end of the second transistor. The first transistor, the second transistor, and the third transistor constitute a plurality of current mirrors.

The present invention further discloses a biasing circuit with fast response. The biasing circuit includes a reference current source, a first transistor, a second transistor, and a voltage buffer. The reference current source has an output end for providing a reference current. The first transistor has a control end, a first connection end, a second connection end, wherein the control end is coupled to the first connection end and the output end of the reference current source, and the second connection end is coupled to a system grounding end. The second transistor has a control end, a first connection end, and a second connection end, wherein the first connection end is coupled to a system power supply end, and the second connection end is coupled to the system grounding end. The voltage buffer has a first input end, a second input end, and an output end, wherein the first input end is coupled to the output end of the reference current source, the first connection end of the first transistor, the control end of the first transistor, the second input end is coupled to the output end, and the output end is coupled to the control end of the second transistor. The first transistor and the second transistor constitute a current mirror. The voltage buffer is a source follower, an emitter follower, or an operational amplifier (op amp) with direct feedback. The biasing circuit is applied to a cascode circuit. The biasing circuit further includes at least a third transistor, wherein a control end of the third transistor coupled to the control end of the first transistor and the control end of the second transistor. The first transistor, the second transistor, and the third transistor constitute a plurality of current mirrors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a biasing circuit with a regulated capacitor according to the prior art.

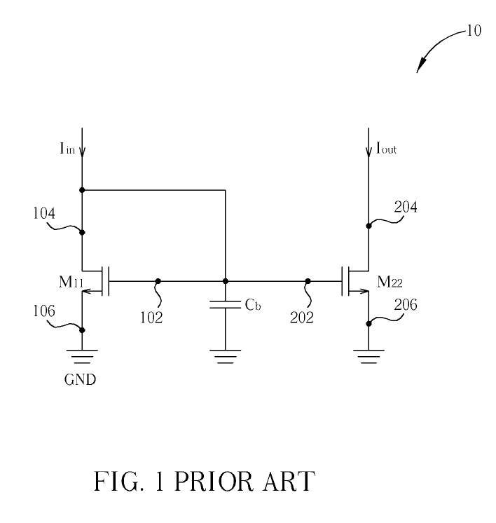

FIG. 2 is a diagram of a biasing circuit capable of increasing slew rate according to the prior art.

FIG. 3 is a diagram of waveforms of the clock signal and the voltage of the node Y shown in FIG. 2.

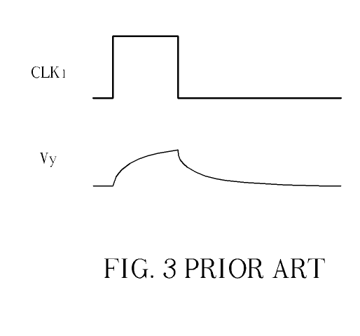

FIG. 4 is a diagram of a biasing circuit with fast response according to an embodiment of the present invention.

FIG. 5 is a diagram of a biasing circuit with fast response according to another embodiment of the present invention.

FIG. 6 is a diagram of a biasing circuit.

FIG. 7 is a diagram of waveforms of the clock signal and the voltage of the node Y shown in FIG. 6.

FIG. 8 is a diagram of a biasing circuit.

FIG. 9 is a diagram of waveforms of the clock signal and the voltage of the node Y shown in FIG. 8.

FIG. 10 is a diagram of a biasing circuit according to a preferred embodiment of the present invention.

FIG. 11 is a diagram of a biasing circuit according to a preferred embodiment of the present invention.

FIG. 12 is a diagram illustrating a biasing circuit implemented by a cascode circuit according to an embodiment of the present invention.

FIG. 13 is a diagram illustrating a biasing circuit implemented by a cascode circuit according to another embodiment of the present invention.

FIG. 14 is a diagram illustrating a biasing circuit implemented by a cascode circuit according to another embodiment of the present invention.

FIG. 15 is a diagram illustrating a biasing circuit implemented by a cascode circuit according to another embodiment of the present invention.

FIG. 16 is a diagram illustrating a biasing circuit implemented by a cascode circuit according to another embodiment of the present invention.

FIG. 17 is a diagram illustrating a biasing circuit implemented by a wide-swing cascode circuit according to an embodiment of the present invention.

FIG. 18 is a diagram illustrating a biasing circuit implemented by a wide-swing cascode circuit according to another embodiment of the present invention.

FIG. 19 is a diagram illustrating a biasing circuit implemented by a wide-swing cascode circuit according to another embodiment of the present invention.

FIG. 20 is a diagram illustrating a biasing circuit implemented by a wide-swing cascode circuit according to another embodiment of the present invention.

### DETAILED DESCRIPTION

In the following embodiments, the used transistors can be implemented by MOS transistors or BJTs (bipolar junction transistor), wherein each transistor has a control end, a first end, and a second end. For the MOS transistor, the control end is a Gate, the first end is a Drain, and the second end is a Source. For the BJT, the control end is a Base, the first end is a Collector, and the second end is an Emitter. In the implementations, an NMOS transistor can be replaced by an NPN type BJT, and a PMOS transistor can be replaced by a PNP type BJT.

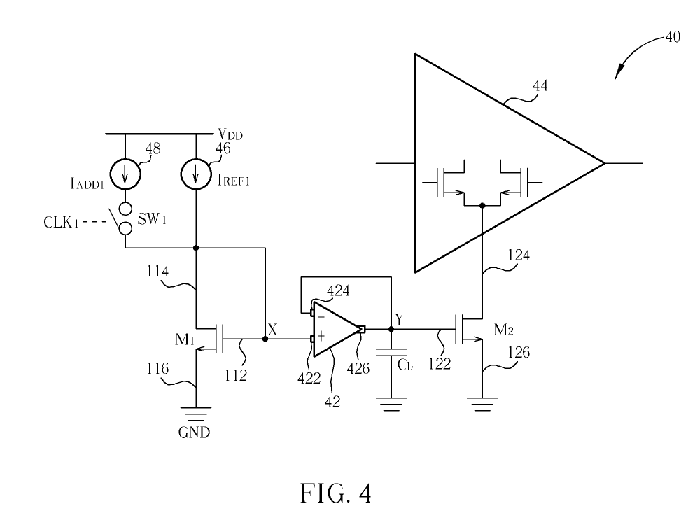

Please refer to FIG. 4. FIG. 4 is a diagram of a biasing circuit 40 with fast response according to an embodiment of the present invention. The biasing circuit 40 includes a reference current source 46, an adjustment current source 48, a first switch SW1, a first transistor M₁, a second transistor M₂, a voltage buffer 42, an output buffer 44, and a regulated capacitor Cb. The reference current source 46 is coupled to a power supply end VDD for providing a reference current I_{REF1}. The adjustment current source 48 is coupled to the reference current source 46 in parallel for providing an adjustment current I_{ADD1}. The first switch SW1 is coupled between the adjustment current source 48 and a first end 114 of the first transistor M₁. The first switch SW1 has a control end for receiving a clock signal CLK₁ and is controlled to be turned on or off according to the clock signal CLK₁. The first transistor M₁ has a control end 112, a first end 114, and a second end 116, wherein the first end 114 is coupled to the reference current source 46 and the first switch SW1. When the first switch SW1 is turned on, the reference current I_{REF1} and the adjustment current I_{ADD1} are received by the first end 114 of the first transistor M₁. When the first switch is turned off, only the reference current I_{REF1} is received by the first end 114 of the first transistor M₁. The second end 116 is coupled to a system grounding end GND. The second transistor M₂ has a control end 122, a first end 124, and a second end 126. The control end 122 of the second transistor M₂ is coupled to an output end 426 of the voltage buffer 42, wherein the joint point is marked as a node Y. The first end 124 is coupled to the output buffer 44, and the second end 126 is coupled to the system grounding end GND. The first transistor M₁, the second transistor M₂, and the voltage buffer 42 constitute a current mirror, and thus the second transistor M₂ provides a corresponding current flowing into the second transistor M₂ according to the current flowing through the first transistor M₁. The voltage buffer 42 has a first input end 422, a second input end 424, and an output end 426. The first input end 422 is coupled to the control end 112 of the first transistor M₁, the first end 114 of the first transistor M₁, and the reference current source 46, whereof the joint point is marked as a node X. The second input end 424 is coupled to the output end 426, the control end 122 of the second transistor M₂, and the regulated capacitor Cb.

Please continue referring to FIG. 4. The voltage buffer 42 is added between the node X and the node Y. Because the regulated capacitor Cb is connected to the node Y, the loading of the node X can be lowered substantially. When the clock signal CLK₁ is transformed from high level to low level (or from low level to high level), the voltage of the node X can be transformed immediately. Thereby the loading of the node Y is pushed by the voltage buffer 42, and the voltage of the node Y can also reach the effect of transforming quickly. In this embodiment, the voltage buffer 42 is an op amp (operational amplifier) with a direct feedback. The first transistor M₁ and the second transistor M₂ are each a MOS transistor or a BJT.

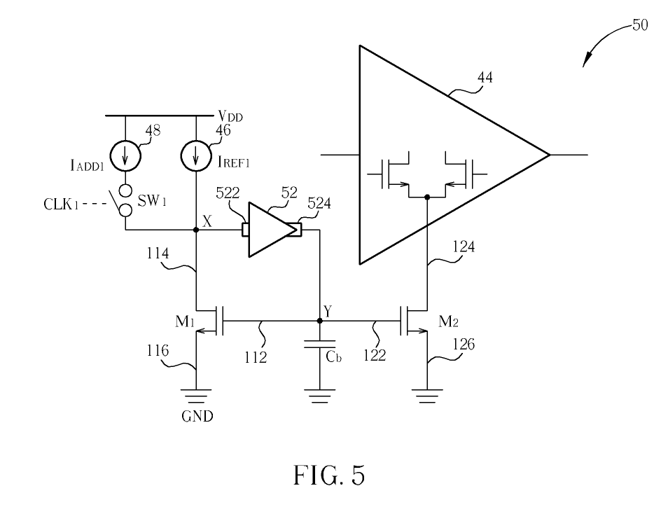

Please refer to FIG. 5 and FIG. 4. FIG. 5 is a diagram of a biasing circuit 50 with fast response according to another embodiment of the present invention. The biasing circuit 50 is similar to the biasing circuit 40, and the difference between them is listed in the following. A voltage buffer 52 of the biasing circuit 50 has an input end 522 coupled to the reference current source 46 and the first end 114 of the first transistor M₁, whereof the joint point is marked as the node X. An output end 524 of the voltage buffer 52 is coupled to the control end 112 of the first transistor M₁, the control end 122 of the second transistor M₂, and the regulated capacitor Cb, whereof the joint point is marked as the node Y. The voltage buffer 52 is added between the node X and the node Y to substantially lower the loading of the node X. When the clock signal CLK₁ is transformed from low level to high level, the first switch SW1 is turned on at this time and the adjustment current I_{ADD1} charges the node X. Due to the loading of the node X being smaller, the voltage of the node X can transform immediately. The voltage buffer 52 then pushes the loading of the node Y, therefore, the voltage of the node Y can increase to the desired voltage level corresponding to the current (I_{REF1}+I_{ADD1}) immediately. On the other hand, when the clock signal CLK₁ is transformed from high level to low level, the voltage of the node Y can reach the effect of discharging quickly through the voltage buffer 52.

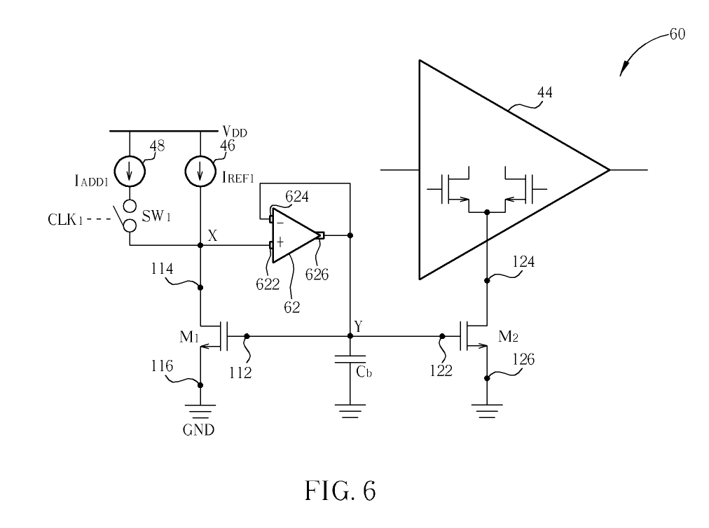

Please refer to FIG. 6 and FIG. 5. FIG. 6 is a diagram of a biasing circuit 60. The biasing circuit 60 is similar to the biasing circuit 50 shown in FIG. 5, and the difference between them is listed in the following. A voltage buffer 62 of the biasing circuit 60 is implemented by using an op amp with unity-gain. A first input end 622 of the voltage buffer 62 is coupled to the reference current source 46 and the first end 114 of the first transistor M₁, whereof the joint point is marked as the node X. A second input end 624 of the voltage buffer 62 is coupled to an output end 626 of the voltage buffer 62, and the output end 626 of the voltage buffer 62 is coupled to the control end 112 of the first transistor M₁, the control end 122 of the second transistor M₂, and the regulated capacitor Cb, whereof the joint point is marked as the node Y. Ideally, the voltage of the node X equals the voltage of the node Y. Practically, the offset voltage of the op amp itself makes the voltage of the node X differ from the voltage of the node Y. When the control end 112 of the first transistor M₁ is connected to the control end 122 of the second transistor M₂, they will have the same VGS voltage, which will result in a relatively smaller current error (i.e., its current error is smaller than that of the biasing circuit 40 in FIG. 4).

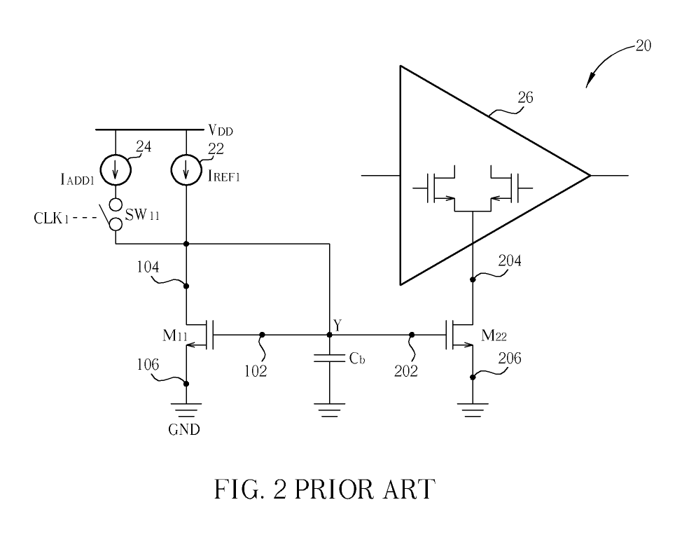

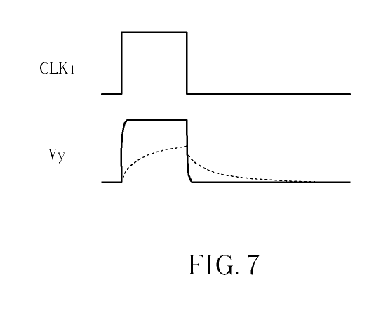

Please refer to FIG. 7 and FIG. 6. FIG. 7 is a diagram of waveforms of the clock signal and the voltage at the node Y shown in FIG. 6. Substantial lines represent the waveform of the voltage Vy at the node Y shown in FIG. 6, and dotted lines represent the waveform of the voltage Vy at the node Y shown in FIG. 2. As can be known from FIG. 7, the voltage buffer 62 is added between the control end 112 and the first end 114 of the first transistor M₁, which can greatly lower the loading of the node X. And then the voltage buffer 62 is used for driving the voltage Vy of the node Y. Therefore, the biasing circuit 60 can improve the rising speed and the falling speed of the voltage of the node Y, which will respond to the slew rate of the output buffer 44.

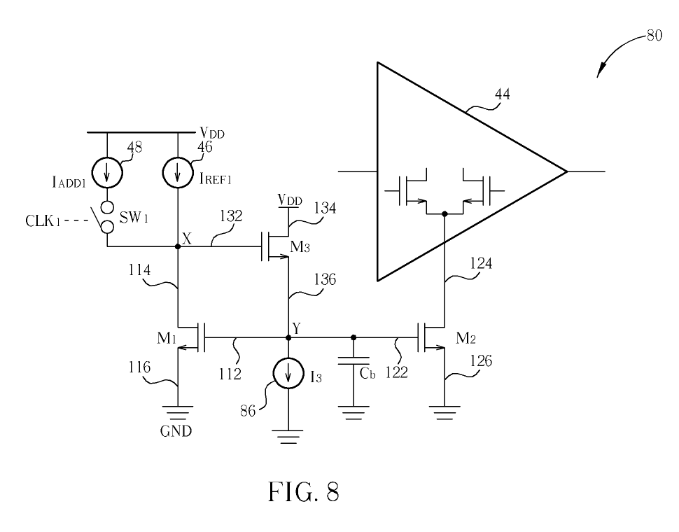

Please refer to FIG. 8 and FIG. 6. FIG. 8 is a diagram of a biasing circuit 80. The biasing circuit 80 is similar to the biasing circuit 60 in FIG. 6, and the difference between them is that the biasing circuit 80 uses a third transistor M₃ of a source follower as the voltage buffer of the biasing circuit 80. The third transistor M₃ has a control end 132, a first end 134, and a second end 136. The control end 132 is coupled to the reference current source 46 and the first end 114 of the first transistor M₁, whereof the joint point is marked as the node X. In this embodiment, the first end 134 of the third transistor M₃ is coupled to the power supply end VDD, and the second end 136 is coupled to a biasing current source 86, the control end 112 of the first transistor M₁, the control end 122 of the second transistor M₂, and the regulated capacitor Cb, whereof the joint point is marked as the node Y. The first end 134 of the third transistor M₃ can be further connected to the power supply end VDD through other elements, which should not restrict the scope of the present invention. The biasing current source 86 is used for providing a biasing current 13 to the third transistor M₃. When the clock signal CLK₁ is transformed from low level to high level, the first switch SW1 is turned on at this time and the adjustment current I_{ADD1} charges the node X. Because the loading of the node X is smaller, the voltage of the node X can transform immediately. The third transistor M₃ then charges the node Y, and thus the voltage of the node Y can rise to the desired voltage level corresponding to the current (I_{REF1}+I_{ADD1}). On the other hand, when the clock signal CLK₁ is transformed from high level to low level, the first switch is turned off at this time. Due to the loading of the node X being smaller, the voltage of the node X can decrease more quickly. The third transistor M₃ is turned off, and the biasing current source 86 discharges the node Y. The first transistor M₁, the second transistor M₂, and the third transistor M₃ are each a MOS transistor or a BJT.

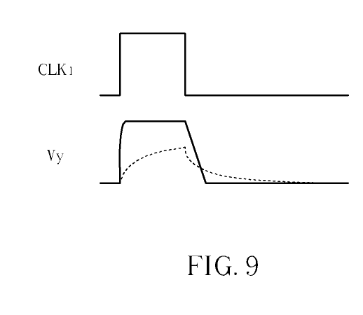

Please refer to FIG. 9 and FIG. 8. FIG. 9 is a diagram of waveforms of the clock signal CLK₁ and the voltage Vy of the node Y shown in FIG. 8. Substantial lines represent the waveform of the voltage Vy at the node Y shown in FIG. 8, and dotted lines represent the waveform of the voltage Vy at the node Y shown in FIG. 2. As can be known from FIG. 9, the third transistor M₃ is added between the control end 112 and the first end 114 of the first transistor M₁, which can greatly lower the loading of the node X. And then the third transistor M₃ is used for driving the voltage Vy of the node Y. Therefore, the biasing circuit 80 can improve the rising speed and the falling speed of the voltage of the node Y, which will respond to the slew rate of the output buffer 44.

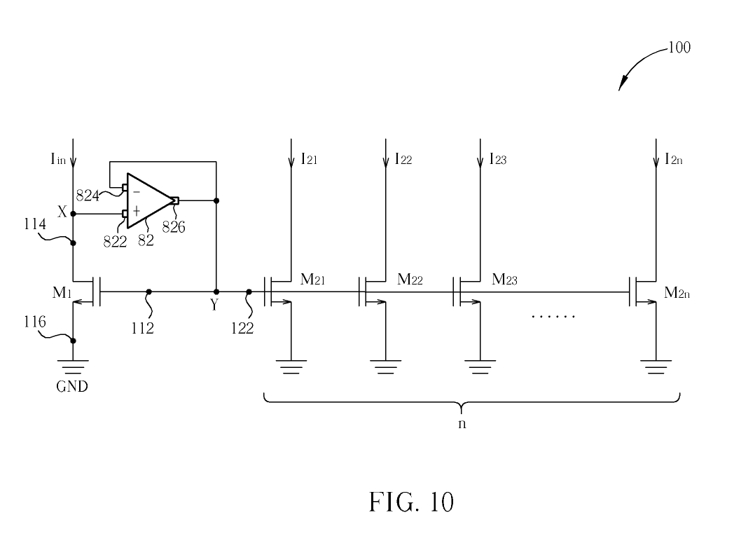

Please refer to FIG. 10. FIG. 10 is a diagram of a biasing circuit 100 according to a preferred embodiment of the present invention. The biasing circuit 100 includes a first transistor M₁, a plurality of second transistors M₂₁-M₂ₙ, and a voltage buffer 82. The first transistor M₁ includes a control end 112, a first end 114, and a second end 116. The first end 114 is coupled to a current source (not shown in FIG. 10) for receiving an input current Iin, and the second end 116 is coupled to the system grounding end GND. The control end 122 of the plurality of second transistors M₂₁-M₂ₙ is coupled to the control end of the first transistor M₁, the first end of the plurality of second transistors M₂₁-M₂ₙ is coupled to a power supply end, and the second end of the plurality of second transistors M₂₁-M₂ₙ is coupled to the system grounding end GND. The first transistor M₁ and the plurality of second transistors M₂₁-M₂ₙ respectively constitute a plurality of current mirrors, and the plurality of second transistors M₂₁-M₂ₙ respectively provide the corresponding output currents I₂₁-I₂ₙ flowing into the plurality of second transistors M₂₁-M₂ₙ according to the input current Iin. The voltage buffer 82 is implemented by using an op amp with unity-gain. A first input end 822 of the voltage buffer 82 is coupled to the current source and the first end 114 of the first transistor M₁, whereof the joint point is marked as the node X. A second input end 824 of the voltage buffer 82 is coupled to an output end 826 of the voltage buffer 82, and the output end 826 of the voltage buffer 82 is coupled to the control end 112 of the first transistor M₁ and the control end 122 of the plurality of second transistors M₂₁-M₂ₙ, whereof the joint point is marked as the node Y.

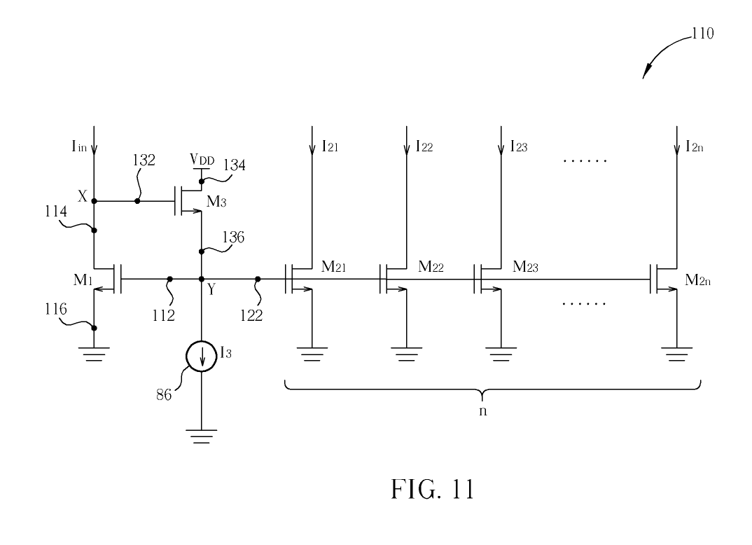

Please refer to FIG. 11. FIG. 11 is a diagram of a biasing circuit 110 according to a preferred embodiment of the present invention. The biasing circuit 110 is similar to the biasing circuit 100 in FIG. 10, and the difference between them is that the biasing circuit 100 uses a third transistor M₃ of a source follower as the voltage buffer of the biasing circuit 110. The third transistor M₃ has a control end 132, a first end 134, and a second end 136. The control end 132 is coupled to the first end 114 of the first transistor M₁, whereof the joint point is marked as the node X. The first end 134 of the third transistor M₃ is coupled to the power supply end VDD, and the second end 136 is coupled to a biasing current source 86, the control end 112 of the first transistor M₁, and the control end 122 of the plurality of second transistors M₂₁-M₂ₙ, whereof the joint point is marked as the node Y. The biasing current source 86 is used for providing a biasing current 13 to the third transistor M₃.

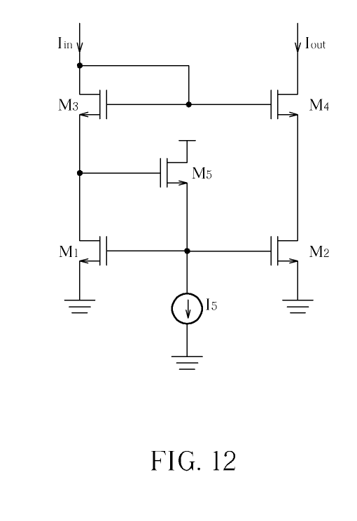

Please refer to FIG. 12. FIG. 12 is a diagram illustrating a biasing circuit implemented by a cascode circuit according to an embodiment of the present invention. In this embodiment, a first transistor M₁ and a second transistor M₂ constitute a current mirror, a third transistor M₃ and a fourth transistor M₄ are coupled to the first transistor M₁ and the second transistor M₂ in a cascode manner, and a fifth transistor M₅ is used as the voltage buffer of the biasing circuit.

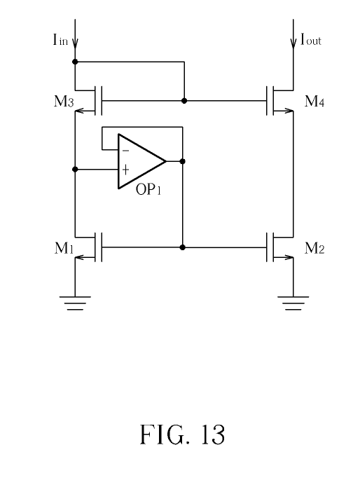

Please refer to FIG. 13. FIG. 13 is a diagram illustrating a biasing circuit implemented by a cascode circuit according to another embodiment of the present invention. In this embodiment, a first transistor M₁ and a second transistor M₂ constitute a current mirror, a third transistor M₃ and a fourth transistor M₄ are coupled to the first transistor M₁ and the second transistor M₂ in a cascode manner, and an operational amplifier OP₁ is used as the voltage buffer of the biasing circuit.

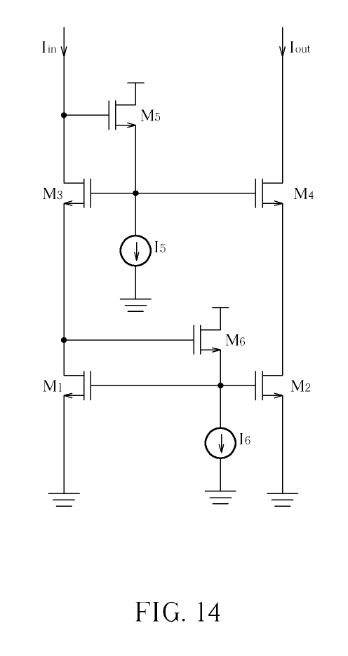

Please refer to FIG. 14. FIG. 14 is a diagram illustrating a biasing circuit implemented by a cascode circuit according to another embodiment of the present invention. In this embodiment, a first transistor M₁ and a second transistor M₂ constitute a first current mirror, and a sixth transistor M₆ is used as the voltage buffer of the first current mirror. A third transistor M₃ and a fourth transistor M₄ constitute a second current mirror and are coupled to the first transistor M₁ and the second transistor M₂ in a cascode manner, and a fifth transistor M₅ is used as the voltage buffer of the second current mirror.

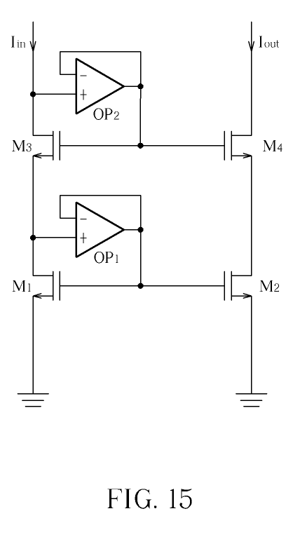

Please refer to FIG. 15. FIG. 15 is a diagram illustrating a biasing circuit implemented by a cascode circuit according to another embodiment of the present invention. In this embodiment, a first transistor M₁ and a second transistor M₂ constitute a first current mirror, and a first operational amplifier OP₁ is used as the voltage buffer of the first current mirror. A third transistor M₃ and a fourth transistor M₄ constitute a second current mirror and are coupled to the first transistor M₁ and the second transistor M₂ in a cascode manner, and a second operational amplifier OP₂ is used as the voltage buffer of the second current mirror.

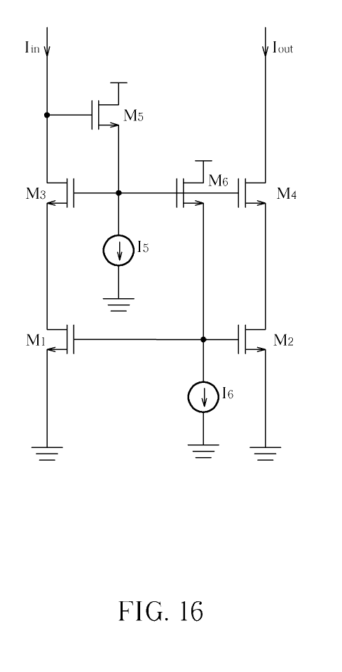

FIG. 16 is a diagram illustrating a biasing circuit implemented by a cascode circuit according to another embodiment of the present invention. In this embodiment, a first transistor M₁ and a second transistor M₂ constitute a first current mirror, and a sixth transistor M₆ is used as the voltage buffer of the first current mirror. A third transistor M₃ and a fourth transistor M₄ constitute a second current mirror and are coupled to the first transistor M₁ and the second transistor M₂ in a cascode manner, and a fifth transistor M₅ is used as the voltage buffer of the second current mirror.

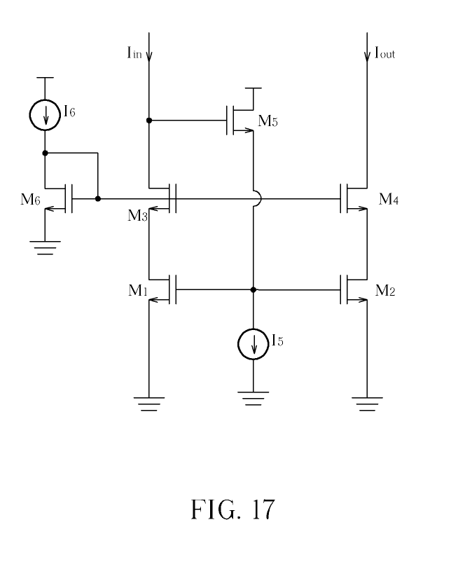

Please refer to FIG. 17. FIG. 17 is a diagram illustrating a biasing circuit implemented by a wide-swing cascode circuit according to an embodiment of the present invention. In this embodiment, a first transistor M₁ and a second transistor M₂ constitute a first current mirror, and a fifth transistor M₅ is used as the voltage buffer of the first current mirror. A third transistor M₃ and a fourth transistor M₄ constitute a second current mirror and are coupled to the first transistor M₁ and the second transistor M₂ in a cascode manner, and a sixth transistor M₆ is used for providing a biasing voltage of the control ends of the third transistor M₃ and the fourth transistor M₄.

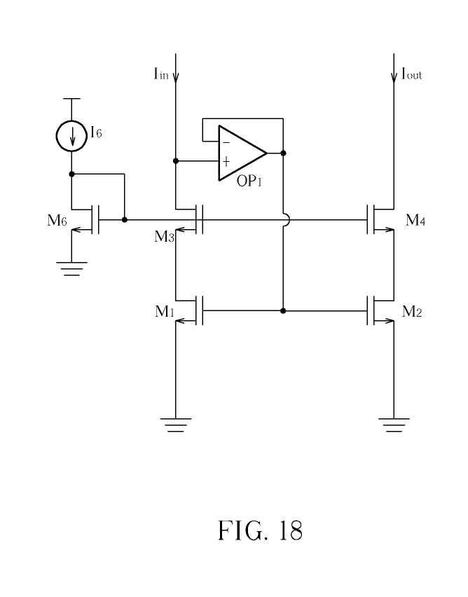

Please refer to FIG. 18. FIG. 18 is a diagram illustrating a biasing circuit implemented by a wide-swing cascode circuit according to another embodiment of the present invention. In this embodiment, a first transistor M₁ and a second transistor M₂ constitute a first current mirror, and a first operational amplifier OP₁ is used as the voltage buffer of the first current mirror. A third transistor M₃ and a fourth transistor M₄ constitute a second current mirror and are coupled to the first transistor M₁ and the second transistor M₂ in a cascode manner, and a sixth transistor M₆ is used for providing a biasing voltage of the control ends of the third transistor M₃ and the fourth transistor M₄. Please compare FIG. 17 with FIG. 18. When the source follower is added into FIG. 17, the wide-swing function disappears. However, the biasing circuit in FIG. 18 is implemented by the first operational amplifier OP₁, and the wide-swing function still exists.

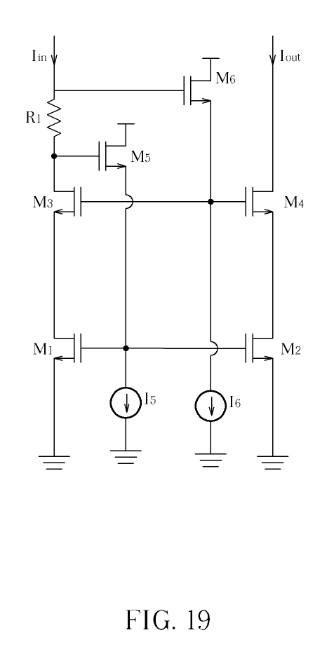

FIG. 19 is a diagram illustrating a biasing circuit implemented by a wide-swing cascode circuit according to another embodiment of the present invention. In this embodiment, a first transistor M₁ and a second transistor M₂ constitute a first current mirror, and a fifth transistor M₅ is used as the voltage buffer of the first current mirror. A third transistor M₃ and a fourth transistor M₄ constitute a second current mirror and are coupled to the first transistor M₁ and the second transistor M₂ in a cascode manner, and a sixth transistor M₆ is used as the voltage buffer of the second current mirror.

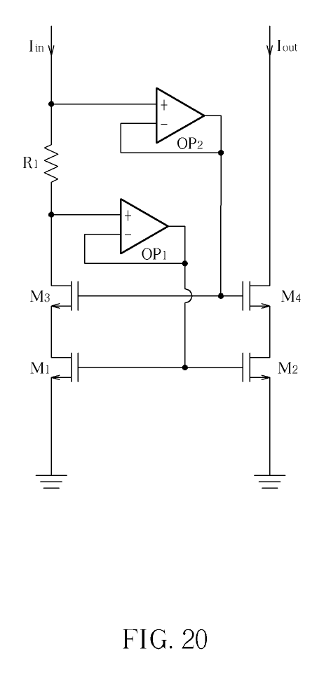

Please refer to FIG. 20. FIG. 20 is a diagram illustrating a biasing circuit implemented by a wide-swing cascode circuit according to another embodiment of the present invention. In this embodiment, a first transistor M₁ and a second transistor M₂ constitute a first current mirror, and a first operational amplifier OP₁ is used as the voltage buffer of the first current mirror. A third transistor M₃ and a fourth transistor M₄ constitute a second current mirror and are coupled to the first transistor M₁ and the second transistor M₂ in a cascode manner, and a second operational amplifier OP₂ is used as the voltage buffer of the second current mirror.

The abovementioned embodiments are presented merely for describing the present invention, and in no way should be considered to be limitations of the scope of the present invention. The abovementioned voltage buffers 42, 52, 62, and 82 can be source followers, emitter followers, or operational amplifiers and their connection manner is not limited to the embodiments disclosed in the present invention. The first transistor M₁, the second transistor M₂, the third transistor M₃, the fourth transistor M₄, the fifth transistor M₅, and the sixth transistor M₆ each can be a MOS transistor or a BJT, and is not limited to this only. In addition, the first transistor M₁ and the plurality of second transistors M₂₁-M₂ₙ can constitute the plurality of current mirrors, and the number of the current mirrors is not limited. Furthermore, the abovementioned biasing circuits 10, 20, 40, 50, 60, 80, 100, and 110 can be applied to cascode circuits or wide-swing cascode circuits.

In summary, the present invention provides a biasing circuit with fast response. Through adding a voltage buffer between the node X and the node Y, the loading at the node X can be greatly lowered, which makes the voltage of the node X transform immediately. And then the voltage buffer is used for driving the loading of the node Y, which makes the voltage of the node Y reach the goal of transforming quickly. The applications of the biasing circuit disclosed in the present invention are wide-spreading, and more particularly, can be applied to current mirrors with fast response. Collocating with the implementation of cascode circuits can not only reach better effect but also improve the slew rate of the output buffer.

Those skilled in the art will readily observe that numerous modifications and alterations of the device and method may be made while retaining the teachings of the invention.

What is claimed is:

1. A biasing circuit with fast response comprising:
a reference current source, having an output end, for providing a reference current;
a first transistor, having a control end, a first connection end, and a second connection end, the first connection end being coupled to the output end of the reference current source and the second connection end being coupled to a system grounding end;
a second transistor, having a control end, a first connection end, and a second connection end, the control end being coupled to the control end of the first transistor, the first connection end coupled to a system power supply end, and the second connection end being coupled to the system grounding end; and
a voltage buffer, having an input end coupled to the output end of the reference current source and the first connection end of the first transistor, and an output end being coupled to the control end of the first transistor and the control end of the second transistor;
wherein the first transistor and the second transistor constitute a current mirror.

2. The biasing circuit of claim 1, wherein the voltage buffer is a source follower.

3. The biasing circuit of claim 1, wherein the voltage buffer is an emitter follower.

4. The biasing circuit of claim 1, wherein the voltage buffer is an operational amplifier (op amp) with direct feedback.

5. The biasing circuit of claim 1 further comprising an adjusting current source, coupled to the reference current source in parallel, the adjusting current source being used for providing an adjustment current.

6. The biasing circuit of claim 5 further comprising a switch, coupled between the adjusting current source and the first connection end of the first transistor, the switch having a control end used for receiving a control signal and for controlling a turning on and turning off of the switch.

7. The biasing circuit of claim 1, wherein the first transistor and the second transistor are metal oxide semiconductor field effect transistors (MOSFET).

8. The biasing circuit of claim 1, wherein the first transistor and the second transistor are bipolar junction transistors (BJT).

9. The biasing circuit of claim 1, wherein the biasing circuit is applied to a cascode circuit.

10. The biasing circuit of claim 1 further comprising:
at least one third transistor, a control end of the third transistor coupled to the control end of the first transistor and the control end of the second transistor, wherein the first transistor, the second transistor, and the at least one third transistor constitute a plurality of current mirrors.

11. A biasing circuit with fast response comprising:
a reference current source, having an output end, for providing a reference current;
a first transistor, having a control end, a first connection end, a second connection end, the control end being coupled to the first connection end and the output end of the reference current source, and the second connection end being coupled to a system grounding end;
a second transistor, having a control end, a first connection end, and a second connection end, the first connection end coupled to a system power supply end, and the second connection end being coupled to the system grounding end; and
a voltage buffer, having a first input end, a second input end, and an output end, the first input end being coupled to the output end of the reference current source, the first connection end of the first transistor, an the control end of the first transistor, the second input end coupled to the output end, and the output end being coupled to the control end of the second transistor;
wherein the first transistor and the second transistor constitute a current mirror.

12. The biasing circuit of claim 11, wherein the voltage buffer is a source follower.

13. The biasing circuit of claim 11, wherein the voltage buffer is an emitter follower.

14. The biasing circuit of claim 11, wherein the voltage buffer is an operational amplifier (op amp) with direct feedback.

15. The biasing circuit of claim 11 further comprising an adjusting current source, coupled to the reference current source in parallel, the adjusting current source being used for providing an adjustment current.

16. The biasing circuit of claim 15 further comprising a switch, coupled between the adjusting current source and the first connection end of the first transistor, the switch having a control end used for receiving a control signal and for controlling a turning on and turning off of the switch.

17. The biasing circuit of claim 11, wherein the first transistor and the second transistor are metal oxide semiconductor field effect transistors (MOSFET).

18. The biasing circuit of claim 11, wherein the first transistor and the second transistor are bipolar junction transistors (BJT).

19. The biasing circuit of claim 11, wherein the biasing circuit is applied to a cascode circuit.

20. The biasing circuit of claim 11 further comprising:
at least one third transistor, a control end of the third transistor coupled to the control end of the second transistor, wherein the first transistor, the second transistor, and the at least one third transistor constitute a plurality of current mirrors.
